(19) United States
(12) Patent Application Publication
(10) Pub. No.: US 2014/0090258 A1
(43) Pub. Date: Apr. 3, 2014

(54) HOLE CLOSURE DEVICE

(71) Applicant: FRITZ LUETTGENS, ERLANGEN (DE)

(72) Inventor: FRITZ LUETTGENS, ERLANGEN (DE)

(21) Appl. No.: 14/025,034

(22) Filed: Sep. 12, 2013

(30) Foreign Application Priority Data
Oct. 2, 2012 (DE) 202012009430.0

(51) Int. Cl. B43L 23/00; B65D 43/22

(52) U.S. Cl. CPC B43L 23/00; B65D 43/22
USPC 30/459; 220/825

(57) ABSTRACT

A hole closure device has a closing element for closing at least one functional opening of a container or body. The functional opening is introduced into a component which is separate from the container or body, the component is inserted into a receiving opening in the container or body. A positioning device is integrally formed on the hole closure device for insertion into the receiving opening in a custom-fit manner.

### CROSS-REFERENCE TO RELATED APPLICATION

This application claims the priority, under 35 U.S.C. § 119, of German application DE 20 2012 009 430.0, filed Oct. 2, 2012; the prior application is herewith incorporated by reference in its entirety.

### BACKGROUND OF THE INVENTION

### Field of the Invention

The present invention relates to a hole closure device having a closing element for closing at least one functional opening of a container or a body. The functional opening in this case is introduced into a component which is separate from the container or from the body. For its part, the component is in turn inserted or fitted into a receiving opening in the container or body.

The functional opening may, for example, be the outlet opening of a tube, the opening of a cosmetics pot or the pencil-guiding channel of a pencil sharpener. The hole closure device serves to seal the functional opening in a dust-tight and watertight manner. The container or body in this case may be produced from a different material to that of the separate component. It may be a material with a different intrinsic value, for example. Due to this functional separation, it is possible to adapt the material properties of the container or body to the requirements of a container or body of this kind. This applies equally to the hole closure device and the separate component.

### SUMMARY OF THE INVENTION

It is accordingly an object of the invention to provide a hole closure device that overcomes the above-mentioned disadvantages of the prior art devices of this general type, which is adaptable to a container or body in reproducible quality, in the context of large-scale production for example.

With the foregoing and other objects in view there is provided, in accordance with the invention, a hole closure device. The hole closure device has a closing element for closing at least one functional opening for a container or a body. The functional opening is formed in a component which is separate from the container or from the body, and the component is inserted into a receiving opening in the container or body. A positioning device is integrally formed with the closing element and is inserted into the receiving opening in a custom-fit manner.

According to the invention, a positioning device is integrally formed on the hole closure device. The hole closure device and the integrally formed positioning device thereby create a prefabricated module, which can be inserted in a custom-fit manner into the receiving opening on the container or body. In particular, material-related tolerances resulting from the guiding properties of the positioning device when inserting the component can be balanced. The positioning device is effective, so to speak, as a positive guide for the component to be used with the hole closure device.

In particular, it is possible for a plurality of container or body types or configurations to be fitted with the same module containing a hole closure device and a positioning device. In this way, a modular system can be achieved on the part of the manufacturer.

In an advantageous embodiment, the positioning device simultaneously acts as a carrier for one or a plurality of fixing elements for fastening the hole closure device along with the component on the container or body. In a further embodiment, form-fitted sealing elements can be provided on the positioning device, in order to seal the hole closure device and the component in relation to the container or body in a dust-tight, gas-tight and moisture-proof manner. A seal of this kind is required, particularly in the case of highly volatile constituents such as those encountered in the field of cosmetics or in the field of medicine.

Finally, the hole closure device itself may also be improved in terms of its sealing properties in relation to the functional opening by conically extending sealing pins. Arc-shaped guides on the closing element can also improve the closing properties of the hole closure device in respect of the functional openings.

In an advantageous embodiment, the closing element of the hole closure device is pivotably mounted on the positioning device with the help of an integral hinge, for example.

The positioning device may finally create a dual function as a bearing for a functional part. For example, a pencil sharpener with one or a plurality of conical pencil-guiding channels as functional openings may be held in the positioning device.

Other features which are considered as characteristic for the invention are set forth in the appended claims.

Although the invention is illustrated and described herein as embodied in a hole closure device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective front view of a hole closure device in an open position according to the invention;

FIG. 2 is a perspective, rear view of the hole closure devioce from FIG. 1;

FIG. 3 is a perspective view of the hole closure device from FIG. 1 with a closing element in its open position and a further closing element in its closed position;

FIG. 4 is a perspective, front view of the hole closure device from FIG. 1 with two inserted double pencil sharpeners as the functional parts;

FIG. 5 is a side view of the hole closure device from FIG. 4; and

FIG. 6 is a perspective view of the hole closure device from FIG. 4 with a closing element in its open position and a further closing element in its closed position.

### DETAILED DESCRIPTION OF THE INVENTION

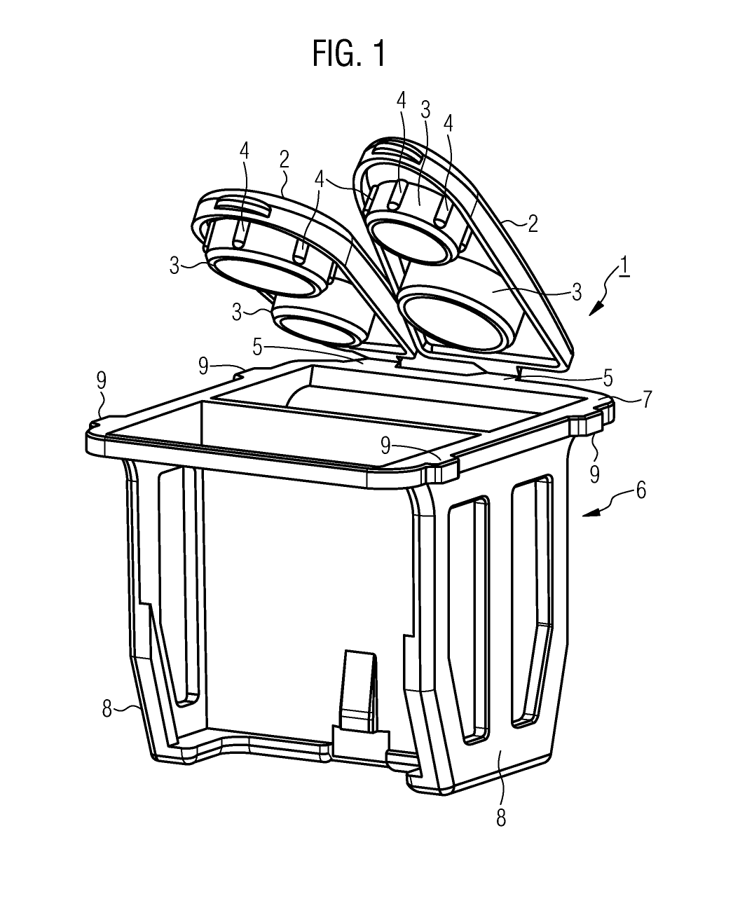

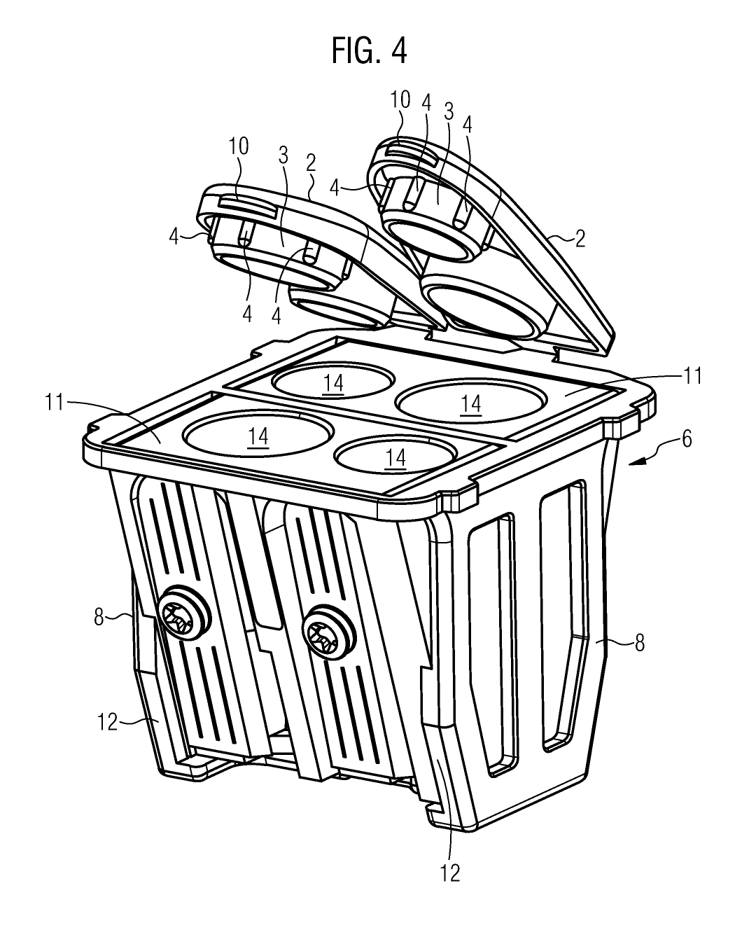

Referring now to the figures of the drawings in detail and first, particularly to FIG. 1 thereof, there is shown a hole closure device 1, which has two closing elements 2 in the exemplary embodiment. The closing elements 2 each carry two closing rings 3 on their undersides. The closing rings 3 each have an arc-shaped guide on their front sides. Evident on the front closing rings 3 are conically extending sealing pins 4. With the closing rings 3, each closing element 2 engages in its closed position in a functional opening 14 (see FIG. 4) of a component separate from the container and likewise not depicted in FIG. 1.

It furthermore emerges from FIG. 1 that the closing elements 2 are pivotably mounted on a positioning device 6 with the help of integral hinges 5. The positioning device 6 contains a circumferential frame 7 which is square in the exemplary embodiment and two side profiles 8 projecting downwardly from the frame 7. The side profiles 8 taper downwardly. If the hole closure device 1 is inserted with its positioning device 6 into a receiving opening in a container or body—not shown in the figures—the downwardly tapering inlet of the side profiles 8 favors the arrangement of the positioning device 6 in the receiving opening on the container. Protrusions 9 projecting laterally from the frame 7 are used as a further positioning and fastening aid for the hole closure device 1 on the container or on the body.

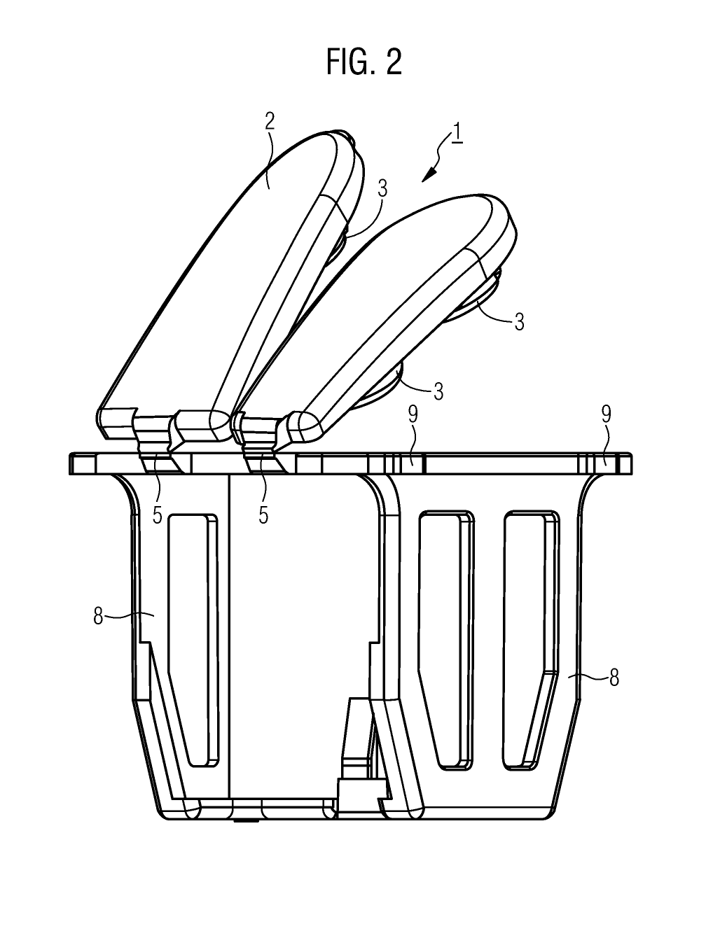

The logo of the manufacturer, the user or some other advertising can be seen printed on the surfaces of the upper sides of the closing elements 2 depicted in FIG. 2. The imprint may be stamped into the surfaces of the closing elements.

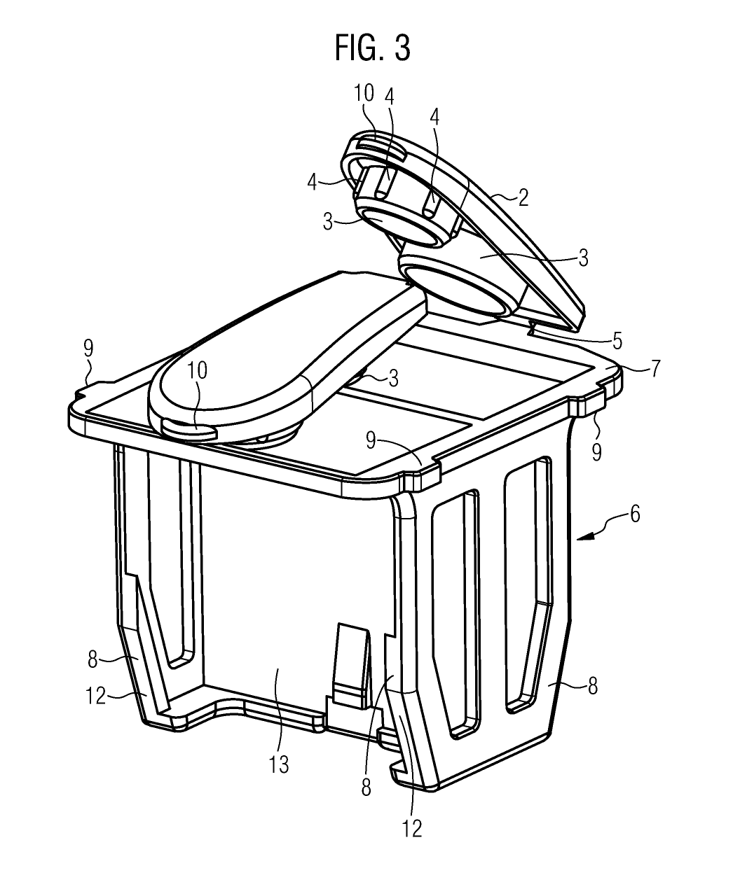

Finally, it can be seen in FIG. 3 that when the closing element 2 is closed, the closing rings 3 project into the area surrounded by the frame 7 and at the same time the edge of the closing element 3 rests with its handle 10 for operating the closing element 2 flush on the frame 7.

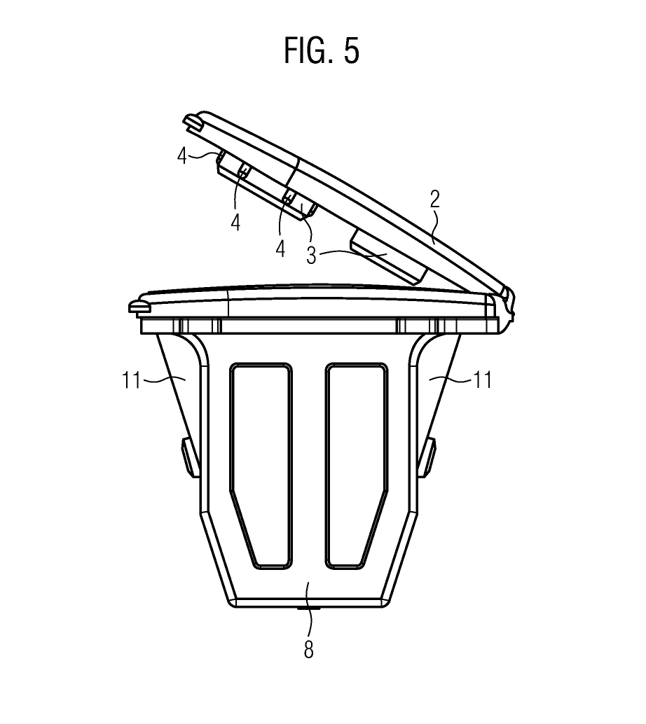

In the case of the exemplary embodiment, the positioning device 6 has a dual function. It serves to receive two double sharpeners 11. The double sharpeners 11 are inserted back-to-back into the positioning device 6 and held in the positioning device 6 by the side profiles 8 and by fixing ribs 12 integrally formed on the side profiles 8. A partition wall 13 connecting the side profiles 8 to one another acts as a further fixing for the dual sharpener 11. The openings of the funnel-shaped pencil-guiding channels of the dual sharpeners 11 create the functional opening 14 in the exemplary embodiment, which can be closed in a dust-tight manner with the help of the closing rings 3 on the closing elements 2 in the exemplary embodiment (see FIGS. 4-5).

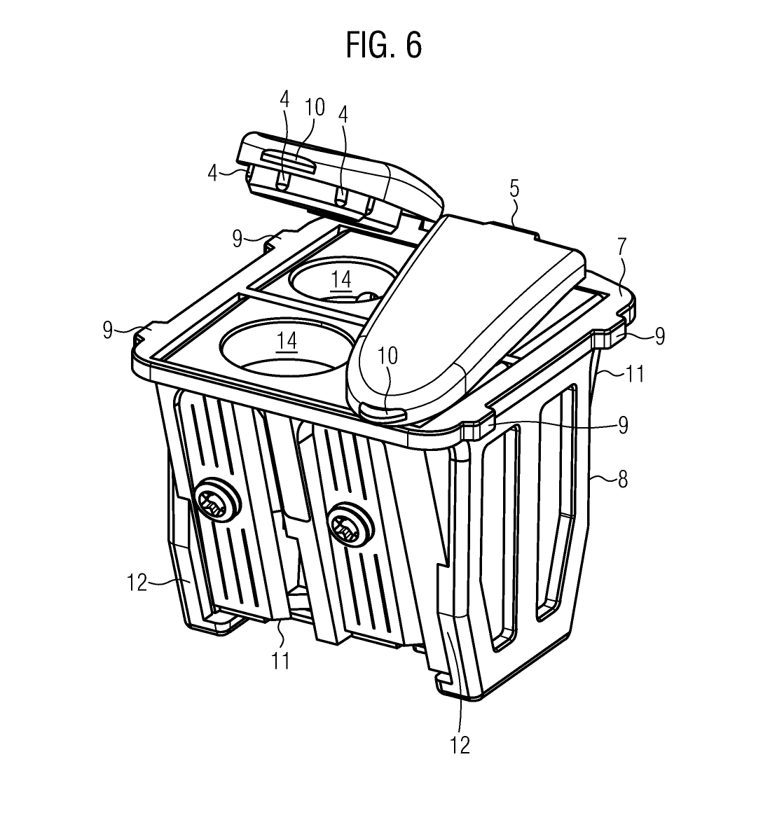

In the closed state, the closing rings 3 lie with the sealing pins 4 in the functional openings 14 at the ends of the funnel-shaped pencil-guiding channels in a frictional manner. This can be seen in FIG. 6.

1. A hole closure device, comprising:
a closing element for closing at least one functional opening for a container or a body, the functional opening being formed in a component which is separate from the container or from the body, the component being inserted into a receiving opening in the container or body; and
a positioning device integrally formed with said closing element and being inserted into the receiving opening in a custom-fit manner.

2. The hole closure device according to claim 1, further comprising fixing elements on said positioning device for fastening on the container or body.

3. The hole closure device according to claim 1, further comprising form-fitted sealing elements disposed on said positioning device.

4. The hole closure device according to claim 1, wherein said closing element has integrally formed, conically extending sealing pins for dust-tight sealing of the functional opening.

5. The hole closure device according to claim 1, further comprising an arc-shaped guide disposed on said closing element.

6. The hole closure device according to claim 1, wherein said closing element is pivotably mounted on said positioning device.

7. The hole closure device according to claim 1, further comprising a functional part mounted on said positioning device and forming a separate component.

8. The hole closure device according to claim 1, wherein said functional part is a pencil sharpener having a conical pencil-guiding channel which forms the functional opening.

9. The hole closure device according to claim 1, wherein the component is a pencil sharpener having a conical pencil-guiding channel which forms the functional opening.
